(19) United States
(12) Patent Application Publication
(10) Pub. No.: US 2013/0324092 A1
(43) Pub. Date: Dec. 5, 2013

(54) BUILT-IN MOBILE DEVICE CALL HANDLER AND ANSWERING MACHINE

(71) Applicant: Daniel E. Scott, Taylorsville, UT (US)

(72) Inventor: Daniel E. Scott, Taylorsville, UT (US)

(21) Appl. No.: 13/907,585

(22) Filed: May 31, 2013

Related U.S. Application Data
(60) Provisional application No. 61/654,693, filed on Jun. 1, 2012.

(51) Int. Cl. H04M 3/533; H04W 4/16

(52) U.S. Cl. CPC H04M 3/533; H04W 4/16
USPC 455/413

(57) ABSTRACT

A call handler and answering machine may be provided in a mobile device having phoning capabilities, and the call handler and answering machine is used to provide additional features related to phoning to the mobile device. Such features include advanced and customized call handling, customized greetings, advanced voice messaging handling, ability to listen in on voice messages and interrupt voice messages as they are being left, talk messaging, and the like.

### CROSS-REFERENCE TO RELATED APPLICATIONS

This application claims the benefit of U.S. Provisional Application No. 61/654,693, filed Jun. 1, 2012.

### BACKGROUND OF THE INVENTION

1. Field of the Invention

The present invention relates to mobile devices having phoning capabilities, and more particularly to a call handler and answering machine for such mobile devices.

2. Background and Related Art

There are a variety of mobile devices having phoning capabilities in use today, including but not necessarily limited to smart phones, some tablet computers, and standard cell phones. While the capabilities of such devices has been growing over time, such devices continue to be limited in certain regards, especially in the ways in which such devices are able to handle incoming calls.

### BRIEF SUMMARY OF THE INVENTION

Implementation of the invention provides a call handler and answering machine providing additional capabilities to mobile devices having phoning capabilities. The call handler and answering machine may be implemented in software and/or hardware, and may be pre-installed on a mobile device or may be installed after the fact. The call handler and answering machine may be installed entirely on the mobile device, or remote resources may be utilized to provide at least certain functions of the call handler and answering machine.

According to implementation of the invention, systems, methods, and non-transitory computer-readable media provide a call handler and answering machine operating on a device capable of providing phoning capability. The call handler and answering machine include one of software, hardware, and a combination of software and hardware configured to answer an incoming call on behalf of the device before the device is caused to notify a user of the device of the incoming call, and provide features related to handling of the incoming call.

The call handler and answering machine may provide a customized ringback tone to the incoming call. The call handler and answering machine may also provide a customized greeting to an incoming caller and provide the incoming caller an opportunity to leave a voice message. Thereafter, the call handler and answering machine records a voice message from the incoming caller locally.

The call handler and answering machine may provide an incoming caller an opportunity to leave a voice message with or without providing a customized greeting. The call handler and answering machine may provide an incoming caller an opportunity to leave a voice message while allowing a user of the device to listen to the voice message as the incoming caller is leaving the voice message. The call handler and answering machine may also allow the user of the device to interrupt the voice message and convert the voice message into an active telephone call.

The call handler and answering machine may be a call handler and answering machine of a recipient device, whereby the call handler and answering machine of the recipient device is configured to recognize an incoming talk message from a call handler and answering machine of a sending device. The call handler and answering machine of the recipient device may be configured to receive the talk message without causing the recipient device to notify a user of the recipient device of the incoming call at least until the talk message has been completely received.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer device for use with embodiments of the invention;

FIG. 2 shows a representative networked computer configuration for use with embodiments of the invention;

FIG. 3 shows a representative prior art method for handling an incoming phone call;

FIG. 4 shows a representative method for handling an incoming phone call in accordance with embodiments of the invention;

FIG. 5 shows a representative generalized method for handling an incoming phone call in accordance with embodiments of the invention; and

FIG. 6 shows a representative display of a mobile device operating in accordance with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

According to embodiments of the invention, systems, methods, and non-transitory computer-readable media provide a call handler and answering machine operating on a device capable of providing phoning capability. The call handler and answering machine include one of software, hardware, and a combination of software and hardware configured to answer an incoming call on behalf of the device before the device is caused to notify a user of the device of the incoming call, and provide features related to handling of the incoming call.

The call handler and answering machine may provide a customized ringback tone to the incoming call. The call handler and answering machine may also provide a customized greeting to an incoming caller and provide the incoming caller an opportunity to leave a voice message. Thereafter, the call handler and answering machine records a voice message from the incoming caller locally.

The call handler and answering machine may provide an incoming caller an opportunity to leave a voice message with or without providing a customized greeting. The call handler and answering machine may provide an incoming caller an opportunity to leave a voice message while allowing a user of the device to listen to the voice message as the incoming caller is leaving the voice message. The call handler and answering machine may also allow the user of the device to interrupt the voice message and convert the voice message into an active telephone call.

The call handler and answering machine may be a call handler and answering machine of a recipient device, whereby the call handler and answering machine of the recipient device is configured to recognize an incoming talk message from a call handler and answering machine of a sending device. The call handler and answering machine of the recipient device may be configured to receive the talk message without causing the recipient device to notify a user of the recipient device of the incoming call at least until the talk message has been completely received.

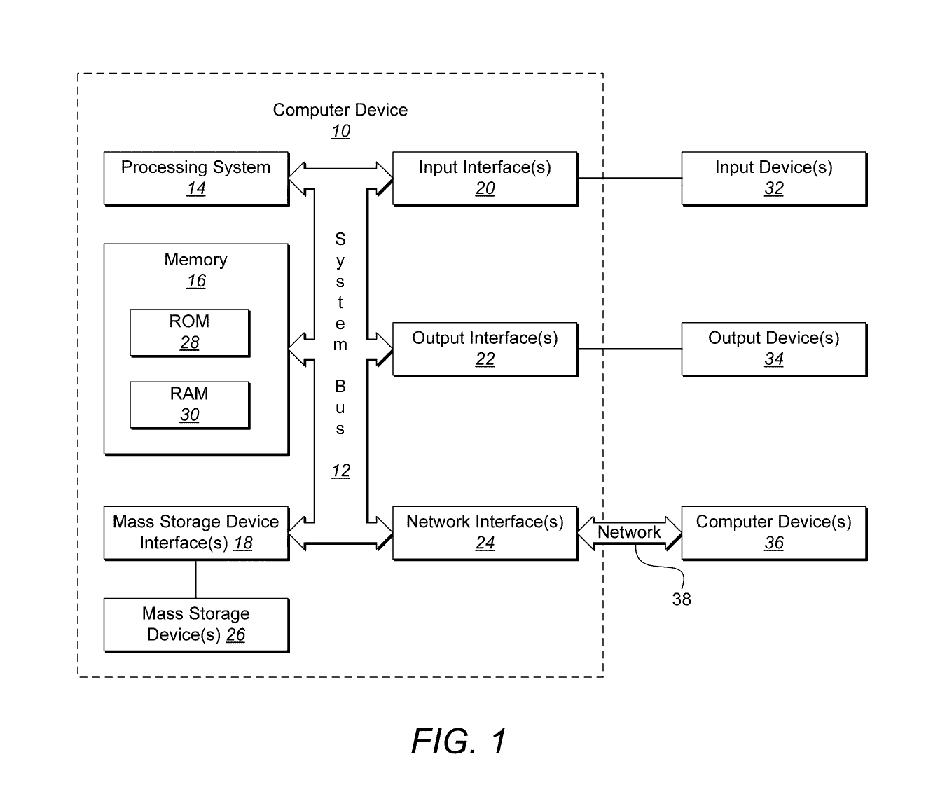

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network 38 may be or may include a cellular network. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

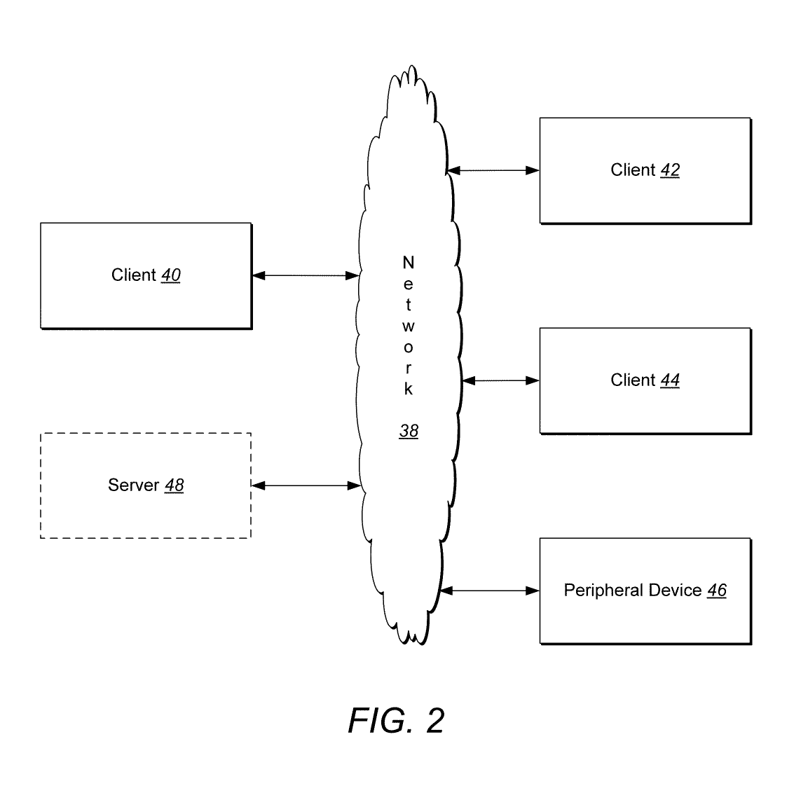

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

As mentioned previously, embodiments of the invention function in conjunction with mobile devices having phoning capabilities. Such devices include, but are not limited to cell phones, smart phones, tablet computers, and the like. Such devices may provide functionality as discussed herein through any combination of hardware and software. Such devices may also provide functionality as discussed herein through hardware and software contained essentially completely on the mobile device. Alternatively, some functionality may be provided in a distributed fashion using remote computing resources, where distribution of computing resources comports with the discussion provided herein.

According to embodiments of the invention, a call handler and answering machine is provided that serves to provide many of the functions discussed herein. The call handler and answering machine may be provided with any combination of hardware and software, and may be preinstalled on a mobile device e.g. by the device manufacturer or a cellular provider. Alternatively, the call handler and answering machine may be installed on the mobile device subsequent to an initial sale of the mobile device. In instances where the call handler and answering machine is installed on the mobile device subsequent to an initial sale of the device, the call handler and answering machine may commonly be provided by software that uses existing hardware resources of the mobile device.

Thus, the call handler and answering machine may be provided as an application or app configured to operate with an operating system of the mobile device. A variety of call handler and answering machine apps may be provided to function with currently existing operating systems and with new operating systems in the future. Existing operating systems include Apple's iOS, Windows Phone, Bada, BlackBerry OS, Palm OS, Android, Symbian OS, and the like. The call handler and answering machine apps may be customized to best utilize mobile device resources of each device and operating system, and therefore there are a large variety of specific call handler and answering machine apps that may be provided in accordance with embodiments of the invention. In embodiments of the invention, the call handler and answering machine is installed on the mobile device and provides its functions on the mobile device.

Regardless of how the call handler and answering machine is implemented, the call handler and answering machine functions to essentially intercept incoming phone calls and provide functionality not previously available with mobile phoning. The call handler and answering machine may run at all times on the mobile device when the mobile device is in communication with the mobile device's network. The call handler and answering machine has access to the mobile device's features (e.g. any combination of hardware and software) that provide the mobile device with phoning capabilities. The call handler and answering machine acts as an additional layer between the user of the mobile device and the mobile device's network. Where existing mobile devices provide an interface between the user and the network, the call handler and answering machine essentially provides an interface between the user and the network, and the call handler and answering machine handles the interactions between the mobile device and the network.

Thus, when an incoming telephone call is to be received by the mobile device, the mobile device does not simply ring as with existing mobile devices, although the user of the mobile device may notice little to no change in the user's experience with the mobile device. Instead, the call handler and answering machine essentially answers all incoming calls, and then decides how to handle the incoming call based on characteristics of the incoming call. The handling of the call by the call handler and answering machine provides many features of embodiments of the invention, and may do so entirely on the mobile device and using resources of the mobile device. In other words, functions discussed herein may be provided without relying on resources available on or through the mobile device network, other than the connection of the call itself.

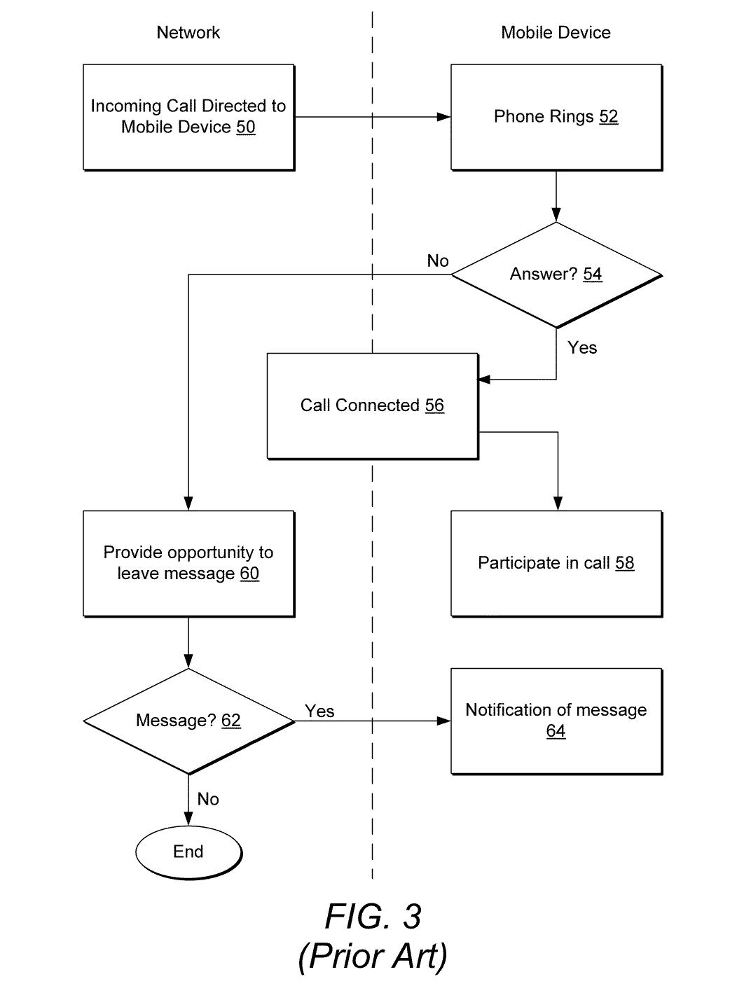

To contrast the handling of incoming calls by the call handler and answering machine, FIG. 3 depicts a typical telephone call received by a mobile device according to current methods. In this method, the network detects an incoming call directed to a particular mobile device at step 50, and directs the incoming call to that mobile device. The mobile device accordingly rings or otherwise notifies the user of the incoming call at step 52. At decision block 54, the user decides whether or not to answer the call, including based on any caller ID information provided by his or her mobile device. If the user opts to answer the call, execution proceeds to step 56, wherein the mobile device and the network cooperate to connect the incoming call, and the user then participates in the call at step 58. If, instead, the user does not answer the call, the network takes over again and may optionally provide the incoming caller with an opportunity to leave a message for the user at step 60. Alternatively, in the case where the user's mobile device is not connected to the network, the network may immediately provide the incoming caller with an opportunity to leave a message for the user at step 60. At decision block 62, a determination is made as to whether a message was received. If a message was received, the network delivers a notification of the message to the mobile device at step 64, otherwise, execution ends.

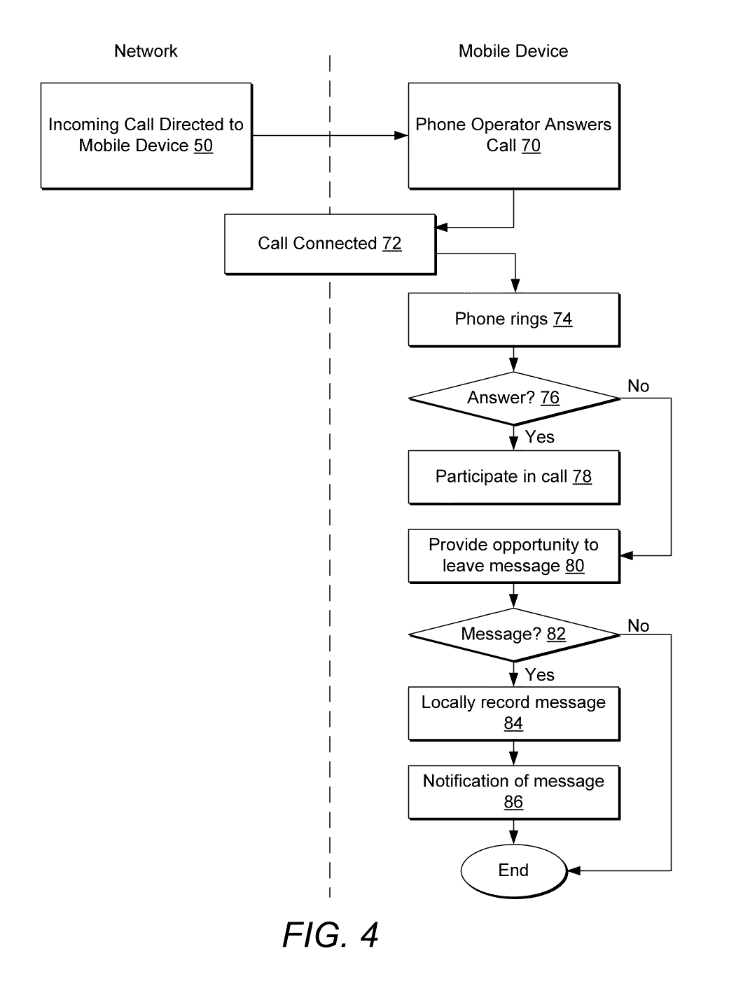

In contrast, FIG. 4 illustrates a method in which the call handler and answering machine is present on the mobile device and handles the incoming call. In cases where the mobile device is not connected to the network, the incoming call may be handled according to existing processes. The process when the mobile device is connected to the network begins similarly, with the network detecting an incoming call directed to a particular mobile device at step 50. The network handles the call in exactly the same way, directing the incoming call to the mobile device. In this case, however, the call handler and answering machine, acting as an additional layer between the network and the user, immediately “answers” the incoming call at step 70. In this example, the call handler and answering machine may answer the call in such a way that the incoming caller may not event detect that from the standpoint of the network the call has been answered. Regardless, at the direction of the call handler and answering machine, the mobile device and the network negotiation the connection of the call at step 72.

From this point forward, the mobile device, at the direction of the call handler and answering machine, handles all functions related to the incoming call. As may be appreciated, this reduces the burden on the network provider, at least insofar as storing any recording that is played to indicate the opportunity to leave a message as well as storing any message that the incoming caller may leave. This also reduces the burden on the network provider when the user wishes to listen to any recorded message. Under existing practice, some users may connect to the network and listen to messages several or many times, and each connection and playing of the message is a repeated strain on the network's resources. For example, a saved voice message may be a remembrance of a lost loved one and users of existing mobile devices may repeatedly access the saved message, using network resources, repeatedly to find comfort with respect to the loss.

Embodiments of the invention as depicted in FIG. 4 completely obviate such draws on network resources. Once the call is connected at step 72, the call handler and answering machine causes the phone/mobile device to ring at step 74. The ringing of the phone may be customized in duration and type according to the incoming caller. Simultaneously, the call handler and answering machine can provide the incoming caller with a notification that the phone is ringing (e.g. a ringback tone) that may be similarly customized, such that the incoming caller is unaware that the incoming call has already been answered by the call handler and answering machine. At decision block 76, a determination is made by the user as to whether to answer the incoming call or not. If yes, the user of the mobile device participates in the call at step 78 and the call proceeds as it normally would with a standard mobile device.

In contrast, if the user does not answer the call or elects not to answer the call, execution proceeds to step 80, where the call handler and answering machine provides the incoming caller with an opportunity to leave a message. Because the phone call was already “answered” at step 70, the provision of an opportunity to leave a message is effectively simply a change in the audio being delivered to the incoming caller over the network, from a ringback tone to a notification to leave a message. At decision block 82, a determination is made as to whether a message is to be recorded. If yes, execution proceeds to step 84, and the message is recorded locally, on the mobile device. Thereafter, a notification of a recorded message can be provided to the user at step 86, the notification being any suitable notification, similar to those currently provided by existing mobile devices. Of course, if no message is to be recorded, execution ends.

The local recording of the message at step 84 allows the call handler and answering machine to provide additional functions not currently available with existing systems. First, as the message is recorded locally, it becomes immediately available on the user's mobile device without requiring any accessing of the network. Thus, if the mobile device is not in communication with the network when the user wishes to listen to the message, the user is not hindered in listening to the recorded message. Instead, the user simply accesses the locally-stored message. Unlike with other systems that remotely record a message and then deliver it at a later time for consumption, the call handler and answering machine locally records and stores the message in real time as part of the original call and makes it immediately available for consumption at the mobile device and without any involvement from the carrier or the network other than through the original call connection. Thus, for example, unlike other systems that remotely record a message and later require some sort of connectivity of the mobile device to obtain the recorded message, the call handler and answering machine makes the recorded message immediately available, in real time, without requiring later network access.

Similarly, because the message is locally stored, the user is able to perform additional actions with respect to the message. For example, the user may attach a file containing the voice mail to an e-mail using an e-mail application on the mobile device. Alternatively, the user may attach a file containing the voice mail to a short message service (SMS) or multimedia message service (MMS) message. Such capability may include a capability to modify a format of the stored message. Alternatively, the capability may include a capability to excerpt and send only a portion of the saved message. Additionally, as will be described in more detail below, the call handler and answering machine may be used to forward a copy of the voice message to the call handler and answering machine of another mobile device as a talk message using voice network capabilities (e.g. a voice phone call) of the respective mobile devices. As another example, the voice message file may be used in conjunction with other programs: a voice message or portion thereof could be calendared on a calendar of the mobile device (any any other synched calendars) to provide an audio reminder at a certain date/time. Then, the recipient could refresh his or her memory at the calendared date/time or at any other desirable time. The call handler and answering machine could even calendar all voice messages, effectively creating a calendar-accessed audio diary of voice messages.

Finally, as the voice message is stored locally, the user may copy and/or transfer a file representing or containing the voice message from the mobile device to any connected storage device and/or other computing device. For example, mobile devices are commonly capable of having mass storage devices (e.g. memory cards) be at least intermittently connected to the mobile devices. Such mass storage devices can be used to copy or transfer files from the mobile devices to other computing devices or may be used for long-term storage of files deposited thereon. Alternatively, the mobile device may act as a mass storage device and may be connected by a wired (e.g. USB) or wireless (e.g. Bluetooth or IEEE 802.11x) connection or combination thereof to one or more other computing devices, and a file representing or containing the voice message can be copied or transferred to the other computing device through the communicative connection.

In some instances, the call handler and answering machine may be configured to automatically take action to copy or archive the voice mail messages so that a copy of the voice mail message exists separate from the user's mobile device. Thus, if the mobile device is later lost or stolen, the user is still able to access the voice mail message from the archived copy. Examples of automatic actions to archive or copy messages include automatic e-mailing of messages as they are received or at a later time, automatic archiving to another computer device of all non-archived messages whenever a communicative connection (whether wired or wireless) to the other computer device is detected, and the like. Alternatively, in some instances, automatic archiving may be delayed until a certain type of communicative connection (e.g. a free or low-cost communicative connection, or a high-speed communicative connection) is available. In some instances, the copying or archiving may be selective at direction of the user, rather than automatic. As desired, multiple redundant copies of messages may be either automatically or selectively made.

As may be appreciated, the ability to natively copy or transfer the voice message without necessarily involving the network of the communications provider not only potentially lightens the use of the network resources, but also provides increased security to the user that his or her important messages will not be lost. When users rely on the communications provider to store their voice mail messages, it is not uncommon for such messages to be lost due a variety of factors. For example, it is possible for such messages to be accidentally deleted due to user error while trying to access the messages (e.g. pressing the key corresponding to ‘delete’ rather than ‘save’). Messages may also be lost due to provider retention policies dictating deletion of stored messages after passage of a certain amount of time. Alternatively, it is possible for such messages to be lost due to provider error, such as during equipment upgrades, power outages, etc. It is also possible for such messages to be lost due to malicious actions of third parties such as hackers or parties that surreptitiously gain access to users' voice mail account information. In some such circumstances, it may be impossible to recover lost voice mail messages.

Service providers will find it advantageous to provide the call handler and answering machine to address these risks and to transfer responsibility for risk of loss from the service provider to the user. When the user knows saving his or her voice mail messages is dependent on his or her own action, the user is likely to be more proactive in taking action to preserve important voice mail messages. Service providers who provide access to the call handler and answering machine are likely to obtain a favorable increase in customer satisfaction due to the advanced handling of the voice messages provided by the call handler and answering machine. Thus it will be highly advantageous for service providers to provide the call handler and answering machine preinstalled or as an option on their mobile devices with phoning capabilities.

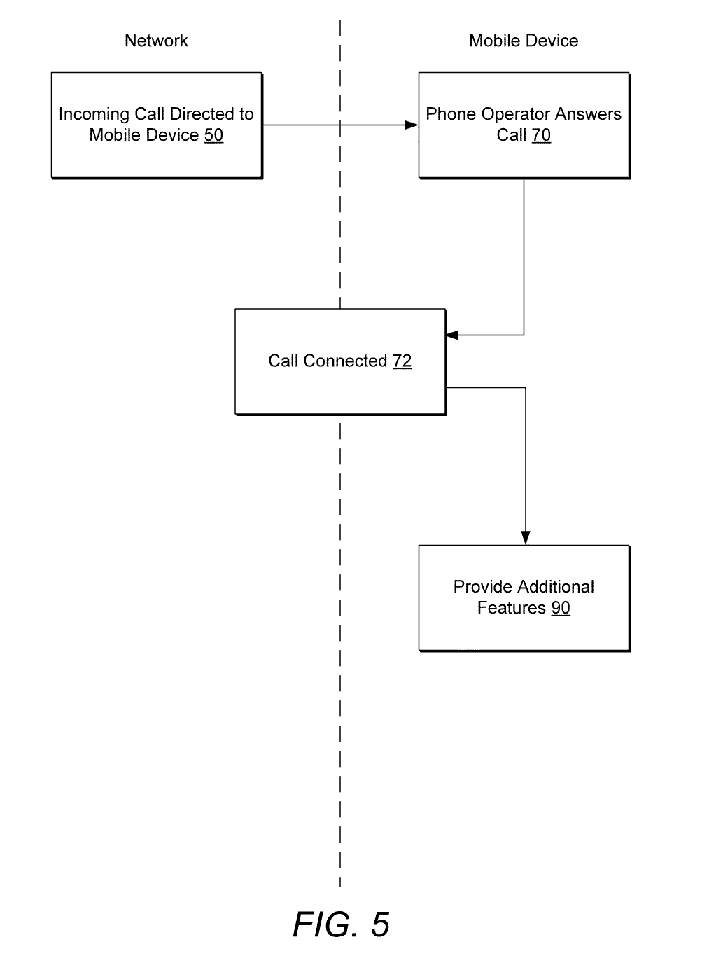

The advanced handling of recorded phone messages is only one feature that may be provided by the call handler and answering machine. In fact, the method illustrated in FIG. 4 is a simplified example of just a single feature that may be provided by the call handler and answering machine. FIG. 5 shows a more generalized flow chart in accordance with embodiments of the invention. Execution begins at step 50, where the mobile device network directs an incoming call to the mobile device. At step 70, the call handler and answering machine at the mobile device “answers” or accepts the call, as has been discussed above. Also as discussed above, the network and the mobile device/call handler and answering machine act together at step 72 to connect the call. At step 90, the call handler and answering machine provides additional features. Such features may be provided exclusively by the call handler and answering machine (operating on the mobile device) and/or the mobile device itself, either acting alone or in conjunction with remote computing resources available to the call handler and answering machine and/or mobile device.

The additional features provided in step 90 may be as simple as providing voice messaging features as discussed in FIG. 4. As may be appreciated by FIG. 4 and the accompanying discussion, the additional features provided by the call handler and answering machine may be provided either to the user of the mobile device, or to the incoming caller, or to both.

A variety of examples may be illustrated of providing additional features to the incoming caller. These features may be available due to the fact that the call handler and answering machine “answers” the call at step 70, such that the incoming caller is no longer waiting for the network to connect the call between the caller's phoning device and the recipient's mobile device. Instead, the call has been connected at step 72, and the call handler and answering machine can determine what to present to the incoming caller. Thus, as discussed above, the call handler and answering machine may provide a standard ringback tone to the incoming caller, such that the incoming caller's experience is essentially identical to that of calling and connecting to a standard mobile device.

Alternatively, the call handler and answering machine may compare incoming caller information (e.g. caller ID information) with a contact list of the user of the mobile device, and may identify that the incoming caller is a person on the user's contact list. The call handler and answering machine may then make a determination as to whether the mobile device's user has designated a custom ringback tone or custom greeting for incoming calls from the incoming caller, and may present the custom ringback tone to that incoming caller instead of a standard ringback tone. The custom ringback tone may be essentially any audio file or track selected by the user, such as a music track, a customized greeting (e.g. “Hi Joe, please wait and see if I can take your call.”), sound effects, a joke, or the like.

Because the custom ringback tone is presented to the incoming caller by the call handler and answering machine on the mobile device after the call has been connected, there are essentially no limits on the custom ringback tone that may be presented to the incoming caller. The custom ringback tone may be of any desired length, and may be customized not only by identity of the incoming caller, but may be further customized by time of day, day of week, length of time since last telephone call between the incoming caller and the user of the mobile device, current news, or essentially any other customization factor. Thus, the incoming caller might never have the same custom ringback tone twice. Indeed, the incoming caller might even be presented with streaming media streamed by the mobile device at the time of the call, such that the incoming caller, while waiting to see if his or her call is to be answered, might be presented with a live news program, a music station, audio of a sporting event, or the like. The incoming caller could even be permitted to change streaming media channels while waiting, such as by pressing keypad numbers on his or her own phoning device.

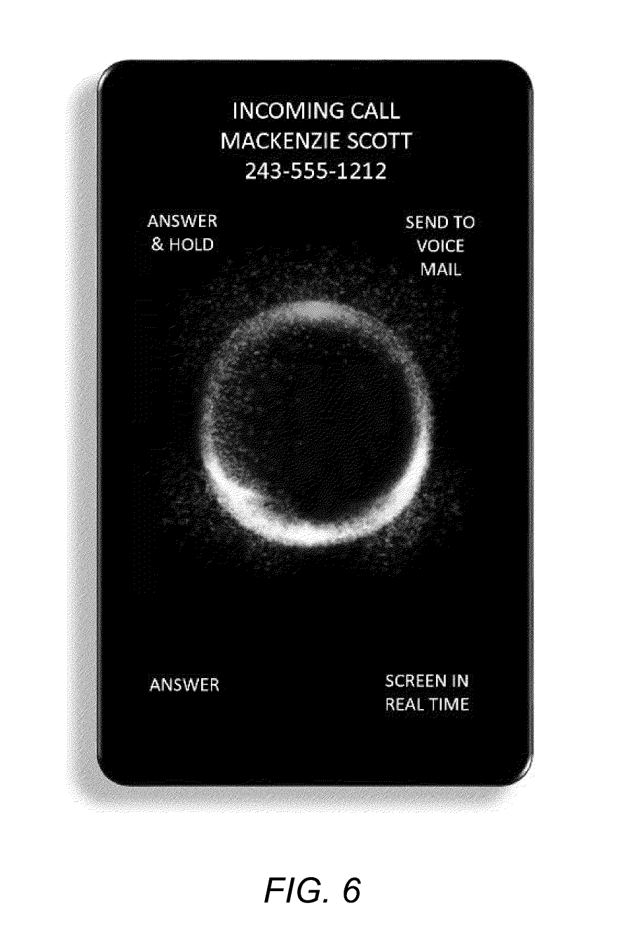

The customized ringback tone need not be limited to customized ringback tones that are preselected by the user or that are selected by the call handler and answering machine and/or mobile device. Instead, the user of the mobile device may be presented with incoming caller information (e.g. the identity of the caller). While the call handler and answering machine may or may not initially select and provide the customized ringback tone, the user of the mobile device may simultaneously be presented with choices as to how to respond to the incoming call. For example, FIG. 6 shows a representative mobile device display that might be displayed to a user of the call handler and answering machine upon receipt of an incoming call. The user might be permitted to select from various call handling options, such as “Answer & Hold,” “Send to Voice Mail,” “Answer,” or “Screen in Real Time.”

If, for example, the user is in a meeting or other situation where it is not socially acceptable to accept the incoming call, but the user can excuse him or herself to take the call, the user might be permitted to select a button so indicating (e.g. “Answer & Hold” in FIG. 6), and the customized ringback tone may be modified accordingly, such as by an interruption message asking the incoming caller to stay on the line. For example, the incoming caller might initially receive a standard or customized ringback tone for a few seconds, until the recipient of the call selects how to handle the call, and then might receive a message such as “I'm in a meeting but want to take your call and am stepping out of the meeting to take your call. Please stay on the line.” The standard or customized ringback tone might then resume.

Such an interruption message might even be recorded in the user's voice, and the user may record a number of such interruption messages. The user may be permitted to select any available such messages or standard interruption messages to be presented to the incoming caller. Such messages may be of significant benefit to incoming callers and mobile device user alike. An interruption message may be discretely selected by the mobile device user without disturbing others in his or her surroundings. Additionally, the incoming call would not be limited to being answered within a set period of time or number of rings, and otherwise the call would be missed. Instead, the incoming caller may be provided with a notification that the call will be taken shortly, and may meanwhile be provided with the customized ringback tone while waiting for the call to be taken.

As is discussed above, the customized ringback tone may be customized based on the identity of the incoming caller, such that no two incoming callers need receive the same customized ringback tone. Additionally, the customized ringback tone may be further customized based on whether or not the incoming caller is on the user's contact list or not. If not, the incoming caller may be presented with a customized ringback tone that asks the incoming caller to identify his or herself. As an example, the incoming caller might receive a ringback tone such as “I don't recognize who you are. Please state your name so I can decide if I can answer your call.” The incoming caller could then state his or her name or other pertinent information.

Meanwhile, the user's mobile device may not yet even have notified the user that there is an incoming call. Instead, the call handler and answering machine may wait until receiving an answer to the customized screening ringback tone, and may then notify the user of the mobile device of the incoming call, presenting the user with any obtained incoming caller information. For example, the call handler and answering machine may audibly state “Incoming call from . . . ” and then play a recording of what was stated by the incoming caller. Alternatively, if voice recognition can be obtained of what was stated by the incoming caller, the information may be presented visually to the user of the mobile device.

This is just one example of call screening that may be made available by the call handler and answering machine. Another example is selective call screening. The user of the mobile device, for example, may be in a situation where it is socially unacceptable generally to answer incoming calls except in the case of emergencies, and wishes to be notified of incoming calls only from certain selected persons on his or her contact list. The user of the mobile device could notify the call handler and answering machine accordingly. As the call handler and answering machine answers and handles all incoming calls, the call handler and answering machine may prevent the mobile device from making any notification of incoming calls other than from the selected persons. Instead, the call handler and answering machine simply directs such calls to voice mail, as depicted in FIG. 4.

If, however, the incoming call is from one of the selected contacts, the call handler and answering machine could notify the user accordingly. The notification to the user could be customized by contact or by any other consideration, such as those outlined above. Thus, if a user receives a phone call from his or her spouse, the phone might vibrate and provide a loud audible alert. In contrast, if the user receives a phone call from his or her employer, the phone might vibrate and provide a soft audible alert. If, however, the user receives a phone call from a particular friend, the phone might only vibrate. These are merely examples of the types of call screening features that could be made available using embodiments of the call handler and answering machine.

Other features may be provided in light of the connected call being handled by the call handler and answering machine. For example, with existing voice messaging systems that are reliant on the service provider's network and systems, once an incoming call has been transferred to the messaging system, the transfer is irreversible. With embodiments of the invention, additional features and options may be provided even once the call has been transferred to voice mail. Such features may mimic features used with physical answering systems in wired phone systems. In such systems, the user could effectively listen in to a message as it was being left and could choose to pick up the line and participate in the call. While similar features have never been available in the mobile device and cellular world, similar features can be readily provided using the call handler and answering machine.

To provide such a feature, the call handler and answering machine may cause the mobile device to display incoming call information (e.g. caller ID, etc.), and may provide the user with several options to respond to the call (which as discussed above has already been “answered” and connected by the call handler and answering machine), as shown in FIG. 6. The options provided to the user may include options such as answering the call, sending the call to voice mail, or sending the call to voice mail with screening (“Screen in Real Time” in FIG. 6). If the user opts to send the call to voice mail with screening, the call handler and answering machine provides the incoming caller with an opportunity to leave a message (which may be customized as discussed above) while allowing the user of the mobile device to listen in on the message as it is being left. During this period of monitoring, any microphone of the mobile device may be muted.

While the message is being left, the call handler and answering machine may cause the mobile device to display additional options to the user. Such options may include playing the incoming message on speakerphone as it is being left, discontinuing listening in on the message as it is being left, and/or interrupting the voice message. If the user selects to interrupt the voice message, the call handler and answering machine unmutes one or more relevant microphones of the mobile device, and the user is able to communicate with the incoming caller as per a regular telephone call, because the call was always connected by the call handler and answering machine. If desired, the call handler and answering machine may be configured or may provide options to continue recording and to save the message and/or the ongoing conversation, or a portion thereof, or may be configured or may provide options to automatically discontinue recording and to discard any recording taken to that point.

Because the mobile device is tied up with an active phone call while any message is being left, the call handler and answering machine may be provided with options to limit the length of incoming callers' voice messages. Such limits may be provided on an individual basis by contact or by unknown contact. Such limits may be selected by the user on the fly as incoming calls are received, or may be previously designated. Limits may also be based on a variety of other factors. For example, the call handler and answering machine may be configured with settings relating to the user's voice plan (e.g. number of minutes, unlimited calling periods, billing cycle, etc.), and the limits for incoming messages may be automatically configured based at least in part on such factors. Thus, if the user appears to be using his or her plan's minutes too quickly for the given billing cycle, the call handler and answering machine may automatically limit incoming message length during certain periods of time, but might allow unlimited length messages during unlimited minutes periods of time (e.g. nights and weekends). Similarly, the call handler and answering machine may limit message lengths during periods of time when the mobile device is roaming instead of in-network.

Because the call handler and answering machine is in control of such features and is also able to provide customized greetings to incoming callers, it may also provide notification of incoming message limits to incoming callers. Thus, the call handler and answering machine may not only indicate to an incoming caller to leave a message, but may also indicate that the incoming message should be limited to a certain length of time (e.g. one minute).

When voice messages are received, the call handler and answering machine can provide a variety of playback features to the user that are not available with standard network-based voice mail access systems. Many mobile devices have advanced input/output features. Such features may permit advanced playback of the recorded voice messages. For example, a touch screen could be used to selectively move to any point within a voice message, such as using a message timeline, scroll bar, or the like. Other controls may be provided to play, pause, quicken playback, slow down playback, or the like. Controls may be provided for adjusting volume, adjusting audio quality such as noise control, treble, or base, or the like. Any of a broad range of audio controls known in the art of audio playback may be provided that are not available using cell phone providers' network call-in systems.

Features and options may also be provided to allow the user to take action with respect to recorded messages and/or to respond to the caller. For example, the user may be provided with options when viewing/listening to a message to send the message by e-mail, MMS message, or the like, to save the message to a file, to add a description to the message, to add notes to the message, to associate the message with calendar items, and the like. One additional benefit that may be provided in accordance with embodiments of the invention is the ability to lock messages to prevent accidental deletion from the mobile device. Taking such an action may prevent accidental message loss that can be all too common with existing systems. In some embodiments, if a lock action is selected, the call handler and answering machine may be configured to automatically archive a copy of the message off device, as has been described previously.

Saved messages may not merely be saved by the call handler and answering machine and/or mobile device, but may be intelligently saved in ways that facilitate later access of saved messages. By way of comparison, existing phone message systems accessed by calling in to the service provider's network messaging system are typically limited to listening to messages in chronological order, such that multiple saved messages might need to be listened to for the user to locate a message of interest. In contrast, the call handler and answering machine in accordance with embodiments of the invention not only may display messages in chronological order, but may also display messages by contact, length, description or notes added by the user, “favorite” status or designation, and any of a variety of other factors. As may be also appreciated, the mobile device may be able to display onscreen multiple voice messages from which to select to listen to, further increasing the speed at which a desired message can be selected for later listening. Similarly, the call handler and answering machine can facilitate navigation of voice messages by selectively displaying contact information, including pictures or even videos, associated with each saved message. Thus, a user seeking a message from a particular contact could do so easily by scanning the messages for a picture of that contact.

The handling of voice messages is an example of the call handler and answering machine providing additional features at step 90. Other features may be provided by the call handler and answering machine to benefit the user of the mobile device. For example, existing caller ID systems are fairly limited in their ability to provide information to the user of the mobile device. Existing systems may provide the name and number of the caller if available, and may cause a device to emit a contact-specific ringtone. In contrast, the call handler and answering machine in accordance with embodiments of the invention can provide the user of the mobile device with video ringtones to convey additional information to the user. For example, as shown in FIG. 6, the portions of the screen used to provide call handling options represent a minor portion of the screen space of the mobile device. The remainder of the screen space is available for providing visual content to the user, which content may optionally be synchronized with audio content.

The video content may include full-motion recorded video content recorded by the user of the mobile device or obtained elsewhere. The video content may also include animations obtained from any source. Additionally, the video content may include one or more still images displayed statically or in motion with transitions and the like. The video and any audio content may more readily and rapidly convey to the user the identity of the incoming call. For example, one family member might incorporate still pictures of other family members into video ringtones assigned to each family member. Then, when an incoming call is received from one of the family members, the recipient can determine at a quick glance or from audio information who is calling.

According to embodiments of the invention, a website is provided that users of the call handler and answering machine could visit to create video ringtones. The users could use media available at the website, could use media readily available on the Internet, or could upload their own media as desired. The media could be incorporated into a video ringtone at the website, and then the video ringtone could be downloaded to the mobile device and associated with a contact or contacts, such that incoming calls from that contact or those contacts would trigger the associated video ringtone. As another alternative, video ringtones could be created on the mobile device itself using media available at the device, including media recorded using inputs of the mobile device, and associated with one or more contacts similarly. Regardless of the method used, creation of the video ringtones may be optimized for the specific mobile device used, and may be created using software optimized for non-technical user creation of the video ringtones.

Video ringtones in accordance with embodiments of the invention can be used in ways that may greatly facilitate social networking and the exchanging of information between users of mobile devices and the like. For example, a user may create a video ringtone for him or herself. Such a video ringtone might not typically be used to identify the user to him or herself. Instead, the user could share the video ringtone with other users and mobile devices. As one example, the user of a mobile device having the call handler and answering machine might encounter someone at a conference with whom the user wishes to exchange contact information. Instead of manually conveying contact information, the user could simply transmit his or her video ringtone to the other device, such as using near field communication or any other appropriate communication method. Then, that other device's call handler and answering machine could display the video ringtone when a call is received from the first user.

Video ringtones that are shared in manners similar to these could also serve as mini or micro advertisements of the users. Thus, for example, a user might create a video ringtone that provides information about the user's abilities, sills, and the like. Then, when the user transmits his video ringtone to other users and then calls those other users, the video ringtone would not only identify the first user's identity, but would advertise his abilities, skills, and the like to others. Businessmen would benefit from the distribution of video ringtones by effectively micro-targeting video ringtone advertisements.

Another feature that may be provided by embodiments of the call handler and answering machine is a method to retrieve and locally store voice mail messages stored remotely by the service provider. As mentioned above, when the mobile device is not connected to the network, such as when the mobile device is out of range or powered down, the service provider may still provide traditional voice message services, allowing incoming callers to leave a message that is stored by the service provider and made available over the network. While this provides flexibility to the user, the remotely-stored messages are subject to all the difficulties discussed previously. Retrieving the messages and storing them locally addresses many of those difficulties.

The call handler and answering machine may retrieve the messages from the service provider over the network using any of a variety of schemes. As a first example, the call handler and answering machine may utilize existing access procedures to cause the carrier's systems to play back the recorded and remotely-stored message. Most carriers allow for a repeated playback of the message upon selection of a replay action (e.g. pressing one of the keypad numbers). According to embodiments of the invention, the call handler and answering machine provides the user with a menu selection item (similar to those shown in FIG. 6) when the user is logged in to the carrier's system. When the user activates the menu selection item, the call handler and answering machine causes the mobile device to send the replay signal back to the carrier. Meanwhile, the call handler and answering machine mutes or otherwise turns of the microphone of the mobile device to prevent recording of ambient sound and records the message as it is played back by the carrier/service provider.

As may be appreciated, this method of obtaining and locally storing the messages from the carrier does not particularly rely on any particular effort or participation by the carrier. In alternate embodiments, the carrier may be willing to more fully participate in the delivery of recorded messages. For example, the burden on computing resources of the carrier may be reduced by having users store their own voice mails. For example, the carrier may automatically “push” voice mail messages to the call handler and answering machine, using either a data or voice connection. Where the voice connection is used, the incoming call may be handled as described above, with the call handler and answering machine accepting the connection without any notification of the incoming call needing to be provided to the user until the full message has been received and stored on the mobile device.

As another alternative, the carrier could automate the retrieval process from its end. The user could select to locally receive a message for on the mobile device storage, and the carrier systems and the call handler and answering machine could communicate directly with each other. The carrier systems could send signals to the call handler and answering machine that would cause the mobile device to mute its microphone, start recording, and stop recording at the appropriate times, such as using tones to signal between the carrier systems and the call handler and answering machine. The user would then only need to assign any desired names and/or contacts to the recorded files to facilitate later access.

Carriers and other service providers would greatly benefit from implementing such systems. Not only would the carriers and service providers reduce the load on their message storage computing systems by reducing the total volume of stored messages, but the carriers and other service providers could obtain a revenue stream by charging additional fees for the use of the automated message push feature as provided by the call handler and answering machine. Carriers could add the feature to push message storage to the mobile device as a separate menu item in their voicemail access systems, or could even automatically push messages to the mobile devices upon reconnection of the mobile devices to the network, e.g. upon power up or on coming in range of the network.

In these various fashions, embodiments of the invention provide multiple improvements for handling of incoming calls that provide a host of features for both the incoming caller and the user of the mobile device and call handler and answering machine. The call handler and answering machine need not be limited to handling of incoming standard calls however. Because the call handler and answering machine “answers” all incoming calls, the call handler and answering machine may be used to provide advanced talk messaging features that mimic the convenience of text messaging without using text messaging or data plans, and without the typically-cumbersome text entry systems of text messaging systems.

These features are provided by the call handler and answering machine through its ability to answer all incoming calls and to otherwise access the mobile device's phoning capabilities. The talk messaging feature allows the user to create a talk message by simply talking into the mobile device while the call handler and answering machine records the talk message as a saved audio file for transmission. The call handler and answering machine then receives any delivery options from the user and delivers the talk message according to the user-selected delivery options. Such options include the person or contact to whom the talk message is to be delivered, any delivery schedule or urgency options, and optionally any alert notifications to be provided to the recipient.

The talk message can be delivered to any standard phone by the call handler and answering machine. The call handler and answering machine places a call to the designated contact and intelligently plays the talk message to the recipient. The call handler and answering machine may provide the recipient options for playing the message multiple times (e.g. by pressing a number on the receiving device), and may also intelligently detect voice messaging systems to leave the talk message at an appropriate moment. Additionally, the call handler and answering machine may play an introduction indicating that a talk message is being delivered so that the recipient does not attempt to interact with the talk message except as appropriate for replaying the talk message or otherwise navigating through the talk message.

While the call handler and answering machine is able to interact with standard phoning devices to deliver talk messages in the fashion described above, the call handler and answering machine is able to intelligently use voice network resources to more efficiently communicate the talk message to any other call handler and answering machine resident on another device. Thus, when the call handler and answering machine of a particular device accepts and connects an incoming call as discussed above, the first thing it may do is determine whether the incoming call is being received from a call handler and answering machine on another device with a talk message to deliver. This can be done using any of a variety of methods, such as is known in the modem communication art, including the use of special tones communicated between the respective call handler and answering machines. Such tones need not be unpleasant or even noticeable in the event one or the other of the phoning devices is being used by a human listener.

If the recipient call handler and answering machine answers a call and recognizes that a sending call handler and answering machine wishes to deliver an incoming talk message, the recipient call handler and answering machine may never notify the recipient user that an incoming call is being received (e.g. the mobile device will not ring). Instead, the recipient call handler and answering machine merely handles the connection, receives the incoming talk message, and then stores and delivers the incoming talk message or notifies the user of the incoming talk message according to any delivery options specified by either the sender or recipient.

In cases where the talk message is delivered from call handler and answering machine to call handler and answering machine, it will be appreciated that the talk message need not be directly played as an audible phone message. Instead, the sending call handler and answering machine may compress the talk message to send the compressed talk message to the recipient call handler and answering machine. Sending of the talk message in compressed form can greatly accelerate transmission, such that the mobile device's phoning capability is occupied for a minimum length of time (e.g. seconds instead of minutes).

While talk messages are being sent and/or received, the call handler and answering machine may notify the user that a talk message is being sent/received and that the voice capability is unavailable. A time may be presented to the user to notify the user of when the transmission should be finished and the voice capability will be available. If the voice call capability is urgently needed, the user may be allowed to interrupt the transmission. Thereupon, the call handler and answering machine(s) may be configured to automatically reestablish a connection between the mobile devices and complete the transmission.

Because the talk message delivered in accordance with the features above does not use the mobile device's data plan or text message plan, it provides an alternative method by which users of mobile devices can communicate. Additionally, because the talk message may be delivered in compressed format, usage of the voice plan can also be greatly limited. Such limitations extend benefits to the service provider as well, as the use of network resources is reduced. Further advantages may be achieved by way of advanced settings when sending talk messages. For example, the system may be instructed to send one or more talk messages only during off-peak unlimited minutes periods of time (e.g. nights and weekends) when delivery time is not critical.

Because delivery of compressed talk messages can be very quick, delivery can even be accomplished in seconds while another call is placed on hold. If, however, delivery cannot be completed on a first attempt, delivery may be achieved by leaving a full-length message on a standard answering system, or delivery may be reattempted later.

The sending user may be provided with the ability to select from a wide variety of options when sending a talk message. The user may select to deliver the talk message at a specific time or when the mobile device is in a period of partial or total inactivity. The user may select to deliver the talk message only when the mobile device is in non-roaming areas, when off-peak unlimited minutes are available, or with any other time restrictions. The user may also designate options related to opening or sharing of the talk message. For example, the user may designate that the recipient should only be notified of the talk message at or after a certain time, regardless of when the recipient device receives the talk message. The user might also designate an urgency of the talk message, such that the recipient's mobile device may provide a different notification or multiple notifications to the recipient if the talk message is not accessed in a timely fashion.

The user might be able to designate that the talk message can only be listened to a certain number of times. Similarly, the user could establish limits on whether the talk message could be saved or otherwise forwarded or shared by the recipient. The user might even designate that the talk message could not be played through the recipient's high-volume speaker, but only through an earpiece. Features such as these may provide some level of security to the talk message.

It may be appreciated that the talk message need not be sent to a single recipient. One benefit of the call handler and answering machine is that it may permit sending of the talk message to multiple recipients. Similarly, sent talk messages can be saved on the sending device and may be accessed, sent to other recipients, resent, saved to external devices, archived, or the like. As with incoming voice messages, such messages can be saved and/or accessed by time sent, by contact, by length, by description, by “favorite” status, or by any other relevant attribute.

Depending on the settings of the received talk message and the settings of the recipient device, the recipient user may be immediately notified of any received talk messages, or may be notified on a schedule chosen by the sender. Because the received talk messages are essentially recorded audio files, any of a variety of actions may be taken with respect to the recorded audio. For example, the recorded audio may be saved or archived to mass storage devices or external computer devices. The recorded audio may also be played at any time and with audio controls as discussed above. Additionally, if voice recognition software is available, the audio file may optionally be parsed and converted into text format to be read by the recipient for alternate consumption.

In some embodiments, received talk messages may be treated differently from standard voice mails. As discussed above, senders and recipients of talk messages may optionally select options controlled by the senders' and receivers' call handlers and answering machines to control such things as delivery time, notifications, play restrictions, and the like. Additionally, unlike existing standard voice message systems that are commonly restricted to organization by time and date received, talk messages may be prioritized and organized by a variety of other mechanisms, such as by contact, length, etc., such that a user of the call handler and answering machine may have talk messages (or indeed any other voice mail) from friends prioritized from other voice mails and talk messages. Where talk messages are delivered from the call handler and answering machine of one device to the call handler and answering machine of another device, the users can cooperatively control treatment and handling of voice messages to achieve desired effects.

The call handler and answering machine allows for other specific treatment of talk messages. For example, a user might find that he or she does not want to receive further talk messages from a certain contact. If, for example, the contact has been leaving obnoxious or offensive talk messages (e.g. stalking), the user can select options on his or her call handler and answering machine instructing the call handler and answering machine to refuse further talk messages from the contact. When the contact's call handler and answering machine attempts to establish a connection for delivery of the next talk message, the user's call handler and answering machine may indicate that talk messages are blocked, e.g. with a message delivered through the contact's call handler and answering machine (or through standard text messaging systems) indicating that “Talk messaging with this person is unavailable at this time.”

Similarly, a user might elect to block receipt of all calls, voice mails, and/or talk messages for a period of time, such as for a period of time during which the user expects to be unavailable (e.g. to attend a movie, appointment, or meeting). The call handler and answering machine may still immediately answer all incoming calls, or it may reject any incoming calls, which would then be handled by the network according to existing or future practices. If the call handler and answering machine answers incoming calls, it may notify incoming callers that the user is unavailable and not taking messages or that the caller is unavailable and that received messages will only be delivered to the user at the time designated by the user. If the call handler and answering machine answers an incoming call from another call handler and answering machine (e.g. a talk message), it can either accept the incoming talk message and notify the incoming call handler and answering machine of the delivery restrictions or it can refuse the incoming talk message and the incoming call handler and answering machine can determine whether to deliver the talk message later or to simply inform the incoming user of the restriction and reason for failed delivery.

Because the call hander and answering machine is able to intelligently interact with other call handlers and answering machines on other devices, the users of call handlers and answering machines can use them to provide intelligent and advanced handling of incoming calls of all types. For example, a husband might instruct his call handler and answering machine to reject all incoming calls and talk messages while he is in a meeting, but may allow his wife's or child's call handler and answering machine to override the restriction or to selectively override the restriction. Thus, the wife or child's call or talk message might be connected or delivered without ever being notified of the restriction, or the wife or child could be notified of the desired restriction and could elect to override the restriction. Similarly, a doctor attending a movie could instruct his or her call handler and answering machine to reject all incoming calls and talk messages except those from his office or call service, such that he could still leave his mobile device on while at the movie and know that his device would not ring and disturb other moviegoers when a friend calls but would still ring (or otherwise notify him or her) if a medical emergency were to occur. The foregoing examples are merely illustrative of the intelligent call handling that can occur with embodiments of the invention.

Thus, embodiments of the invention provide new features and benefits not currently available to users of mobile devices. Such features and benefits are provided by way of the call handler and answering machine. While the call handler and answering machine has been described as operating on the mobile device independently from the service provider or its network, it should be appreciated that variations of the call handler and answering machine are embraced by the embodiments of the invention. For example, as the call handler and answering machine becomes common, users of standard land-line phone systems may wish to obtain features provided by the call handler and answering machine, and the call handler and answering machine may be installed in such systems. As another alternative, some or all features of the call handler and answering machine may be adopted by service providers and be provided at the network level, such as when users' mobile devices are not in communication with the service providers' networks (e.g. are turned off, are actively handling a different call, etc.). Thus embodiments of the inventions are not necessarily limited to use with or on mobile devices only, but use with mobile devices is illustrative of features of embodiments of the invention.

Appended hereto are pages describing and depicting features and uses of embodiments of the invention, and such pages are expressly incorporated into this description by reference.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A call handler and answering machine operating on a device capable of providing phoning capability, the call handler and answering machine comprising:
one of software, hardware, and a combination of software and hardware configured to:
answer an incoming call on behalf of the device before the device is caused to notify a user of the device of the incoming call; and
provide features related to handling of the incoming call.

2. A call handler and answering machine as recited in claim 1, wherein the call handler and answering machine provides a customized ringback tone to the incoming call.

3. A call handler and answering machine as recited in claim 1, wherein the call handler and answering machine provides a customized greeting to an incoming caller and provides the incoming caller an opportunity to leave a voice message.

4. A call handler and answering machine as recited in claim 3, wherein the call handler and answering machine records a voice message from the incoming caller locally.

5. A call handler and answering machine as recited in claim 1, wherein the call handler and answering machine provides an incoming caller an opportunity to leave a voice message.

6. A call handler and answering machine as recited in claim 5, wherein the call handler and answering machine records a voice message from the incoming caller locally.

7. A call handler and answering machine as recited in claim 1, wherein the call handler and answering machine provides an incoming caller an opportunity to leave a voice message and allows a user of the device to listen to the voice message as the incoming caller is leaving the voice message.

8. A call handler and answering machine as recited in claim 7, wherein the call handler and answering machine allows the user of the device to interrupt the voice message and convert the voice message into an active telephone call.

9. A call handler and answering machine as recited in claim 1, wherein the call handler and answering machine is a call handler and answering machine of a recipient device, and wherein the call handler and answering machine of the recipient device is configured to recognize an incoming talk message from a call handler and answering machine of a sending device.

10. A call handler and answering machine as recited in claim 9, wherein the call handler and answering machine of the recipient device is configured to receive the talk message without causing the recipient device to notify a user of the recipient device of the incoming call at least until the talk message has been completely received.

11. A non-transitory computer-readable medium storing computer program instructions to cause a device capable of providing phoning capability to execute a method, the method comprising:
answering an incoming call on behalf of the device before the device is caused to notify a user of the device of the incoming call;
establishing a phone connection between the device and a source of the incoming call; and
providing features related to handling of the incoming call.

12. A non-transitory computer-readable medium as recited in claim 11, wherein providing features related to handling of the incoming call comprises providing a customized ringback tone to the incoming call.

13. A non-transitory computer-readable medium as recited in claim 11, wherein providing features related to handling of the incoming call comprises providing a customized greeting to an incoming caller and providing the incoming caller an opportunity to leave a voice message.

14. A non-transitory computer-readable medium as recited in claim 13, the method further comprising recording a voice message from the incoming caller locally.

15. A non-transitory computer-readable medium as recited in claim 11, wherein providing features related to handling of the incoming call comprises notifying a user of the device of the incoming call and receiving input from the user to deliver a custom greeting to the incoming call.

16. A non-transitory computer-readable medium as recited in claim 15, the method further comprising recording a voice message from the incoming caller locally.

17. A non-transitory computer-readable medium as recited in claim 11, wherein providing features related to handling of the incoming call comprises providing an incoming caller an opportunity to leave a voice message and allowing a user of the device to listen to the voice message as the incoming caller is leaving the voice message.

18. A non-transitory computer-readable medium as recited in claim 17, the method further comprising allowing the user of the device to interrupt the voice message and converting the voice message into an active telephone call.

19. A non-transitory computer-readable medium as recited in claim 11, wherein providing features related to handling of the incoming call comprises recognizing an incoming talk message from a call handler and answering machine of a sending device.

20. A non-transitory computer-readable medium as recited in claim 19, wherein the method further comprises receiving the talk message without causing a recipient device to notify a user of the recipient device of the incoming call at least until the talk message has been completely received.
